(19) United States
(12) Patent Application Publication
(10) Pub. No.: US 2026/0200492 A1
(43) Pub. Date: Jul. 16, 2026

(54) METHOD AND SYSTEM FOR DRIVER MONITORING, AND APPARATUS FOR THE SAME

(71) Applicant: ELECTRONICS AND TELECOMMUNICATIONS RESEARCH INSTITUTE, Daejeon (KR)

(72) Inventors: Cheon In OH, Daejeon (KR); Woo Jin KIM, Daejeon (KR); Seung Jun LEE, Daejeon (KR); Dae Sub YOON, Daejeon (KR)

(21) Appl. No.: 19/370,367

(22) Filed: Oct. 27, 2025

(30) Foreign Application Priority Data
Dec. 17, 2024 (KR) 10-2024-0188100

(51) Int. Cl. B60W 50/16; B60W 40/08; B60W 50/14

(52) U.S. Cl. CPC B60W 50/16; B60W 40/08; B60W 2040/0827; B60W 2050/143; B60W 2540/229; B60W 2556/20

(57) ABSTRACT

Disclosed are a method and a system for driver monitoring and an apparatus for the same. The method for driver monitoring may include: generating an abnormal state detection signal based on detection of a driver's abnormal state; determining whether the driver's abnormal state is falsely detected based on a driver's response to the abnormal state detection signal; and determining whether to generate a warning signal based on determination of whether the driver's abnormal state is falsely detected.

### CROSS-REFERENCE TO RELATED APPLICATION

This application claims the benefit of earlier filing date and right of priority to Korean Application No. 10-2024-0188100, filed on Dec. 17, 2024, the contents of which are all hereby incorporated by reference herein in their entirety.

### BACKGROUND

### 1. Field of the Invention

The present disclosure relates to a method for driver monitoring, and more particularly, to a method and a system for driver monitoring capable of preventing false detection of an abnormal state of a driver, and an apparatus therefor.

### 2. Description of Related Art

Currently, before a driver monitoring system (DMS) can be sold, it must undergo a pre-assessment to ensure compliance with relevant national standards and certification regulations, such as Euro NCAP (European New Car Assessment Programme), UNECE (United Nations Economic Commission for Europe), and EU GSR (European Union General Safety Regulation), as well as vehicle manufacturer requirements. The typical assessment process involves installing a DMS in a vehicle and subjecting hundreds of drivers to predefined driving scenarios over several months. This guides the driver's behavior and determines whether the DMS recognizes the driver's condition and effectively detects abnormalities. The vehicle can then utilize the DMS's detection results to take follow-up measures, such as providing warning messages, such as vibrations or sounds, to ensure safe driving.

For example, if the driver closes their eyes for a certain period of time, the DMS must be able to determine that the driver is asleep. Furthermore, to recognize a wide range of driver states, DMS manufacturers spend significant time and cost acquiring training data for each required scenario behavior during the development phase.

### SUMMARY

A technical object of the present disclosure is to provide a system and a method for driver monitoring, which can collect response data for false detection scenarios during the development of a driver monitoring system and utilize the same to flexibly and efficiently respond to changes in specifications and reduce the probability of false detection occurrence, and to a device therefor.

The technical objects to be achieved by the present disclosure are not limited to the above-described technical objects, and other technical objects which are not described herein will be clearly understood by those skilled in the pertinent art from the following description.

A method for driver monitoring according to one aspect of the present disclosure may include: generating an abnormal state detection signal based on detection of a driver's abnormal state; determining whether the driver's abnormal state is falsely detected based on a driver's response to the abnormal state detection signal; and determining whether to generate a warning signal based on determination of whether the driver's abnormal state is falsely detected. The warning signal may be configured to be generated after a preconfigured time from detection of the driver's abnormal state.

An apparatus for driver monitoring according to an additional aspect of the present disclosure may include: at least one processor; and at least one memory operably connected to the at least one processor and storing instructions that, when executed by the one or more processors, cause the apparatus to perform operations. The operations may include: generating an abnormal state detection signal based on detection of a driver's abnormal state; determining whether the driver's abnormal state is falsely detected based on a driver's response to the abnormal state detection signal; and determining whether to generate a warning signal based on determination of whether the driver's abnormal state is falsely detected. The warning signal may be configured to be generated after a preconfigured time from detection of the driver's abnormal state.

At least one non-transitory computer-readable medium storing at least one instruction according to an additional aspect of the present invention, wherein the at least one instruction executable by at least one processor may control an apparatus for driver monitoring to: generate an abnormal state detection signal based on detection of a driver's abnormal state; determine whether the driver's abnormal state is falsely detected based on a driver's response to the abnormal state detection signal; and determine whether to generate a warning signal based on determination of whether the driver's abnormal state is falsely detected. The warning signal may be configured to be generated after a preconfigured time from detection of the driver's abnormal state.

Preferably, whether the driver's abnormal state is falsely detected may be determined based on data on a driver's normal response to a warning message for an abnormal state during driving according to a specific driving scenario and data on a driver's abnormal response to a random warning message.

Preferably, based on determination that the driver's abnormal state is not falsely detected, i) the warning signal may be generated, or ii) the warning signal generated after the preconfigured time may be maintained.

Preferably, based on determination that the driver's abnormal state is falsely detected within the preconfigured time, the warning signal may be configured not to be generated after the preconfigured time.

Preferably, based on determination that the driver's abnormal condition is falsely detected after the preconfigured time, the warning signal generated after the preconfigured time may be stopped.

According to an embodiment of the present invention, since the driver's behavior and condition can be reduced from being mistakenly determined as abnormal even when they are normal, the reliability of the driver monitoring system can be improved by not causing discomfort to the driver by not outputting unnecessary warning messages, and the vehicle can be prevented from being controlled incorrectly, thereby helping in safe driving.

In addition, according to an embodiment of the present invention, since data collection for a false detection module can be managed by scenario and actual vehicle data can be utilized, it is possible to quickly and cost-effectively respond to changes in driver monitoring system certification standards and provide continuous performance improvement.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a driver data collection system according to one embodiment of the present invention.

FIG. 2 illustrates an example of configuring normal response learning data and a detection model according to one embodiment of the present invention.

FIG. 3 illustrates a procedure for collecting normal driver response learning data according to one embodiment of the present invention.

FIG. 4 illustrates a procedure for storing driver response data due to the random generation of warning messages according to one embodiment of the present invention.

FIG. 5 is a diagram illustrating a driver monitoring system according to one embodiment of the present invention.

FIG. 6 is a flowchart illustrating a method for preventing false detection of driver abnormalities according to one embodiment of the present invention.

FIG. 7 is a diagram illustrating a method for driver monitoring according to one embodiment of the present invention.

FIG. 8 is a block diagram of a driver monitoring device according to one embodiment of the present invention.

### DETAILED DESCRIPTION

Since the present disclosure can make various changes and have various embodiments, specific embodiments will be illustrated in the drawings and described in detail in the detailed description. However, this is not intended to limit the present disclosure to specific embodiments, and should be understood to include all changes, equivalents, and substitutes included in the feature and technical scope of the present disclosure. Similar reference numbers in the drawings refer to identical or similar functions across various aspects. The shapes and sizes of elements in the drawings may be exaggerated for clearer explanation. For a detailed description of the exemplary embodiments described below, refer to the accompanying drawings, which illustrate specific embodiments by way of example. These embodiments are described in sufficient detail to enable those skilled in the art to practice the embodiments. It should be understood that the various embodiments are different from one another but are not necessarily mutually exclusive. For example, specific shapes, structures and characteristics described herein with respect to one embodiment may be implemented in other embodiments without departing from the spirit and scope of the disclosure. Additionally, it should be understood that the position or arrangement of individual components within each disclosed embodiment may be changed without departing from the spirit and scope of the embodiment. Accordingly, the detailed description that follows is not to be intended in a limiting sense, and the scope of the exemplary embodiments is limited only by the appended claims, together with all equivalents to what those claims assert if properly described.

In the present disclosure, terms such as first, second, etc. may be used to describe various components, but the components should not be limited by the terms. The above terms are used only for the purpose of distinguishing one component from another. For example, a first component may be referred to as a second component, and similarly, the second component may be referred to as a first component without departing from the scope of the present disclosure. The term “and/or” includes any of a plurality of related stated items or a combination of a plurality of related stated items.

When a component of the present disclosure is referred to as being “connected” or “accessed” to another component, it may be directly connected or connected to the other component, but other components may exist in between. It must be understood that it may be possible. On the other hand, when it is mentioned that a component is “directly connected” or “directly accessed” to another component, it should be understood that there are no other components in between.

The components appearing in the embodiments of the present disclosure are shown independently to represent different characteristic functions, and do not mean that each component is comprised of separate hardware or one software component. That is, each component is listed and included as a separate component for convenience of explanation, and at least two of each component can be combined to form one component, or one component can be divided into a plurality of components to perform a function, and each of these components can be divided into a plurality of components. Integrated embodiments and separate embodiments of the constituent parts are also included in the scope of the present disclosure as long as they do not deviate from the essence of the present disclosure.

The terms used in this disclosure are only used to describe specific embodiments and are not intended to limit the disclosure. Singular expressions include plural expressions unless the context clearly dictates otherwise. In the present disclosure, terms such as “comprise” or “have” are intended to designate the presence of features, numbers, steps, operations, components, parts, or combinations thereof described in the specification, but are not intended to indicate the presence of one or more other features. It should be understood that this does not exclude in advance the possibility of the existence or addition of elements, numbers, steps, operations, components, parts, or combinations thereof. In other words, the description of “including” a specific configuration in this disclosure does not exclude configurations other than the configuration, and means that additional configurations may be included in the scope of the implementation of the disclosure or the technical feature of the disclosure.

Some of the components of the present disclosure may not be essential components that perform essential functions in the present disclosure, but may simply be optional components to improve performance. The present disclosure can be implemented by including only essential components for implementing the essence of the present disclosure, excluding components used only to improve performance, and a structure that includes only essential components excluding optional components used only to improve performance is also included in the scope of rights of this disclosure.

Hereinafter, embodiments of the present disclosure will be described in detail with reference to the drawings. In describing the embodiments of the present specification, if it is determined that a detailed description of a related known configuration or function may obscure the gist of the present specification, the detailed description will be omitted, and the same reference numerals will be used for the same components in the drawings. Redundant descriptions of the same components are omitted.

Safety certification standards are constantly evolving, reflecting the development of autonomous vehicles and transportation infrastructure. Current certification standards focus solely on detecting the driver's state, and therefore do not address issues arising from false detections (i.e., incorrect detections, misdetection, detection errors), such as misidentifying the driver as drowsy and issuing unnecessary warnings even when the driver is not drowsy. In particular, when utilizing DMS results for vehicle control, such as braking, false detections can significantly impact safety, therefore, a solution is necessary. Furthermore, during the DMS development phase, only a limited amount of data can be collected, including environmental variables such as illumination, and various driver responses. Therefore, it is difficult to continuously incorporate new regulations and achieve performance improvements quickly and at low cost.

In order to solve these problems, the present invention proposes a system structure capable of preventing false detections and efficiently responding to regulatory changes from the learning data collection stage during DMS development to actual vehicle operation after DMS installation, and proposes procedures and methods for the system structure.

The present invention proposes a driver data collection system and a DMS structure and method that collects driver response data when a warning message is received while the driver is in a normal driving state and utilizes this data to filter out warning messages resulting from false positives, thereby reducing cases where the DMS incorrectly determines that the driver is in an abnormal state even when the driver is in a normal driving state. Furthermore, the present invention proposes a driver data collection system and a DMS structure and method that enable the actual collection of driver responses in false detection situations from the vehicle to improve performance in future updates.

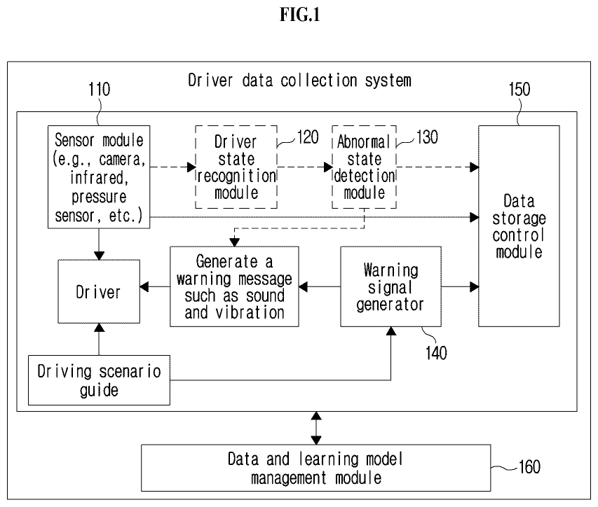

FIG. 1 illustrates a driver data collection system according to one embodiment of the present invention.

FIG. 1 illustrates the structure of the driver data collection system proposed in the present invention during the DMS development phase. Driver response data is collected by providing drivers with behavioral guidance for each driving scenario according to certification standards. Response data from separate vehicle warning messages may not be considered.

Referring to FIG. 1, the driver data collection system may be configured to include a sensor module (e.g., camera, infrared, pressure sensor, etc.) (110), a driver state recognition module (120), an abnormal state detection module (130), a warning signal generator (140), and a data storage control module (150). The data and learning model management module (160) may be included within the driver data collection system or may be configured separately outside the driver data collection system.

The sensor module (e.g., camera, infrared, pressure sensor, etc.) (110) comprises one or more various sensors for detecting the driver's state. Here, the driver can drive according to the driving scenario guide.

The driver state recognition module (120) can recognize the driver's state based on data sensed by the sensor module (110).

The abnormal state detection module (130) can detect whether the driver's current state is abnormal based on the driver state recognized by the driver state recognition module (120). If the abnormal state detection module (130) detects an abnormal driver state, it can generate a warning message, such as a sound or vibration.

The warning signal generator (140) can output warning messages according to the driving scenario guide.

The data storage control module (150) can collect response data when a warning signal is randomly generated to increase the accuracy of preventing false detections, as well as driver response data when a warning signal is generated after detecting an actual abnormal state.

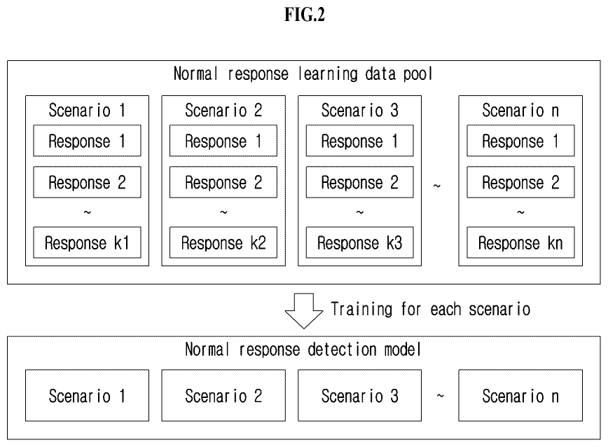

The driver's normal response data can be individually stored for each scenario, and a normal response detection model trained using the driver's normal response data can be individually stored for each scenario. This is described with reference to FIGS. 1 and 2.

FIG. 2 illustrates an example of configuring normal response learning data and a detection model according to one embodiment of the present invention.

In the normal response data collection phase for each scenario, driver data responding to messages generated by detecting actual abnormal states are collected using the driver state recognition module and abnormal state detection module of the DMS, as depicted by the dotted line in FIG. 1, developed using data collected in a conventional manner. These data are then stored for each scenario (see FIG. 2). Furthermore, a normal response detection model trained using the stored data is also stored for each scenario (see FIG. 2).

Here, training a normal response detection model for each scenario uses a variable number of response data, such as k1, . . . , kn, for each scenario. The normal response detector, comprised of detection models for various scenarios, is later used to filter response data due to the occurrence of random warning signals. Various existing machine learning and deep learning techniques can be used for the detector, and are not included in the scope of the present invention.

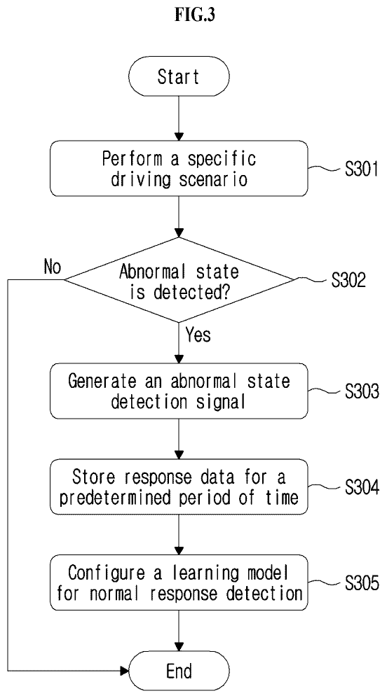

An example of the above operation is shown in FIG. 3.

FIG. 3 illustrates a procedure for collecting normal driver response learning data according to one embodiment of the present invention.

As shown in FIG. 3, the process of collecting driver's normal response learning data comprises a step in which the driver drives according to a scenario such as drowsy driving that must be able to detect a specific abnormal state, and when the driver data collection system, as shown in FIG. 1, detects the driver's abnormal state and outputs a warning message, data on this is collected for a certain period of time.

Referring to FIG. 3, the driver data collection system performs a specific driving scenario (e.g., a drowsy driving scenario) (S301). In other words, the driver data collection system can guide the driver's actions based on a specific driving scenario.

The driver data collection system (e.g., an abnormal state detection module) determines whether the driver's abnormal state is detected (S302).

If an abnormal state is detected in step S302, the driver data collection system (e.g., a warning signal generator) generates/outputs an abnormal state detection signal (S303).

The driver data collection system (e.g., a data storage control module) stores the driver's response data to the abnormal state detection signal for a predetermined period of time (e.g., stored in the data and learning model management module) (S304).

Conversely, if no driver abnormality is detected in step S302, the subsequent steps are terminated without execution.

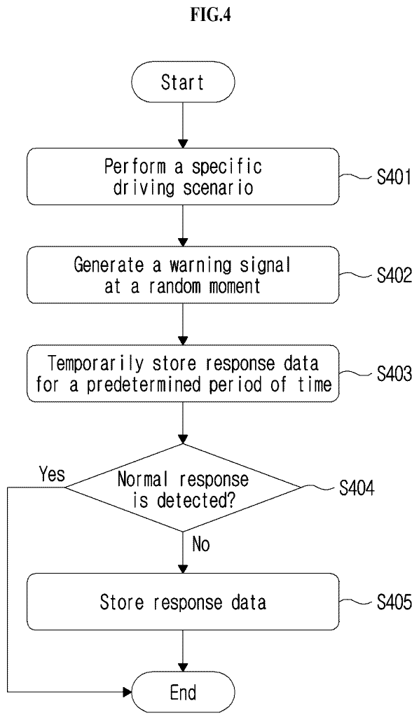

Next, in a normal driving scenario where the driver does not need to receive a warning message, response data is collected when a warning message is unexpectedly outputted to the driver via the warning signal generator in FIG. 1. The procedure is as shown in FIG. 4.

FIG. 4 illustrates a procedure for storing driver response data due to the random generation of warning messages according to one embodiment of the present invention.

Referring to FIG. 4, the driver data collection system performs a specific driving scenario (e.g., a normal driving scenario) (S401). In other words, the driver data collection system can guide the driver's actions by specifying a specific driving scenario.

The driver data collection system (e.g., a warning signal generator) generates/outputs a warning signal at a random moment (S402).

The driver data collection system temporarily stores the driver's response data to the warning signal for a certain period of time (S403).

The driver data collection system uses the normal response learning model and its detector for each scenario, as shown in FIG. 2, according to the procedure in FIG. 3, to determine whether the response is normal (S404).

If the driver's response is determined to be abnormal in step S404, the driver data collection system stores the data as abnormal response data (S405). This represents a data filtering procedure to increase accuracy, as driver responses to arbitrary warning messages may not differ significantly from normal responses.

On the other hand, in step S404, if the driver's response is determined to be normal, the procedure ends.

A false detection device can be configured using driver response data obtained through random occurrences of warning messages. Various existing machine learning and deep learning techniques can be used for the false detection, and are not within the scope of the present invention.

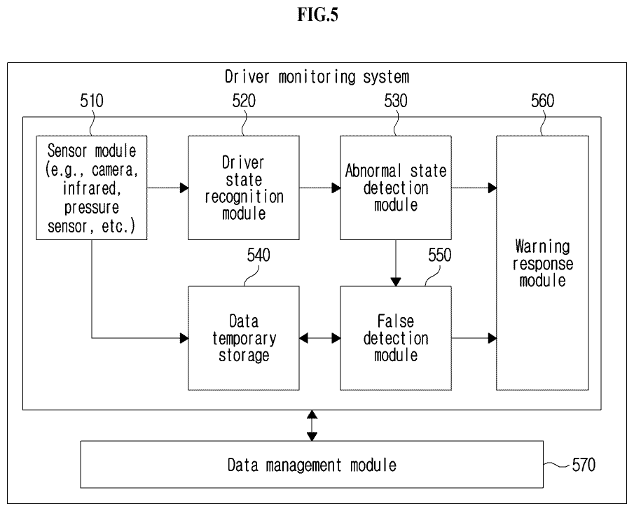

FIG. 5 is a diagram illustrating a driver monitoring system according to one embodiment of the present invention.

Referring to FIG. 5, the driver monitoring system may be configured to include a sensor module (e.g., camera, infrared, pressure sensor, etc.) (510), a driver state recognition module (520), an abnormal state detection module (530), a data temporary storage (540), a false detection module (550), and a warning response module (560). The data management module (570) may be included within the driver monitoring system or configured separately outside the driver monitoring system.

The sensor module (510) comprises one or more sensors for detecting the driver's state (e.g., a camera, infrared, pressure sensor, etc.).

The driver state recognition module (520) can recognize the driver's state based on data sensed by the sensor module (510).

The abnormal state detection module (530) can detect whether the driver's state is currently abnormal based on the driver's state recognized by the driver state recognition module (520).

The temporary data storage (540) temporarily stores sensed response data for a predetermined period of time to detect the driver's state. The false detection module (550) temporarily stores the response data necessary to determine whether a false detection has been detected despite the driver's normal state.

The false detection module (550) determines whether the driver's response to the abnormal state detection signal represents a response in the presence of an abnormal state or a response in the absence of an abnormal state, based on the driver's normal response data and abnormal response data collected by the driver data collection system according to FIG. 1.

The warning response module (560) determines how to output a warning signal to the driver.

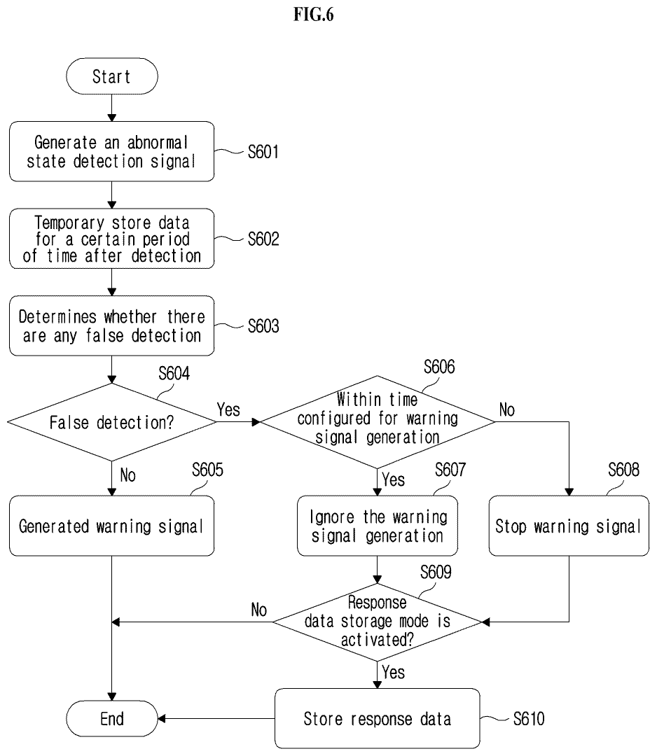

FIG. 6 is a flowchart illustrating a method for preventing false detection of driver abnormalities according to one embodiment of the present invention.

Referring to FIG. 6, if the driver monitoring system (DMS) (or device) installed in the vehicle detects an abnormal driver state while the vehicle is in operation, it generates an abnormal state detection signal before immediately outputting a warning signal (S601).

The driver monitoring system (DMS) (or device) temporarily stores the driver's response data to the abnormal state detection signal for a specified period of time (S602).

The driver monitoring system (DMS) (or device) (e.g., false detection module) uses temporarily stored response data to determine whether the driver's response to the abnormal state detection signal corresponds to an abnormal state or a non-abnormal state (S603, S604). For example, the driver monitoring system (DMS) (or device) determines whether the driver's response to the abnormal state detection signal corresponds to an abnormal state or a non-abnormal state based on the driver's normal response data and abnormal response data collected by the driver data collection system.

Here, the driver monitoring system (DMS) (or device) temporarily stores response data and determines whether there are any false detection. If a preconfigured time (e.g., the minimum time required for a warning signal to be generated) is exceeded, the system generates a warning signal for safety purposes. In other words, a warning signal is generated by default after a preconfigured time has elapsed since the detection of an abnormal driver state.

If the detection of the driver's abnormal state is determined to be non-false at step S604, the driver monitoring system (DMS) (or device) generates a warning signal or maintains an already generated warning signal (e.g., a default warning signal generated after a preconfigured time) (S605).

If the detection of the driver's abnormal state is determined to be false at step S604, the driver monitoring system (DMS) (or device) determines whether the false detection occurred within a preconfigured time (e.g., the minimum configured time for warning signal generation) (S606).

If the driver's abnormal state is determined to be a false detection within a preconfigured time (e.g., the minimum configured time for warning signal generation) at step S606,, the driver monitoring system (DMS) (or device) ignores the warning signal generation and prevents it from being generated even after the preconfigured time (S607).

Conversely, if the preconfigured time (e.g., the minimum configured time for warning signal generation) has been exceeded at step S606, the previously generated warning signal (e.g., the default warning signal generated after the preconfigured time) is stopped to prevent the driver from receiving any unnecessary warning messages (S608).

Here, if the response data storage mode is activated (S609), the driver monitoring system (DMS) (or device) performs a procedure to store the response data for future use (S610). The stored response data is acquired in an actual driving environment and can supplement any gaps in the DMS (or device)'s learning data collection. Therefore, the DMS (or device) can use it to prevent false detection during future software updates.

On the other hand, if the response data storage mode is not activated (S609), the procedure ends.

When environmental conditions or specific driving scenarios change or are added to the certification standards, requiring updates to the false detection module, only normal response learning data and response data generated by random warning signals need to be collected for those specific cases, enabling rapid and low-cost service provision. Furthermore, if the driver monitoring system (DMS) (or device) can utilize diverse false detection response data acquired from multiple vehicles during actual vehicle operation, continuous performance improvements can be expected.

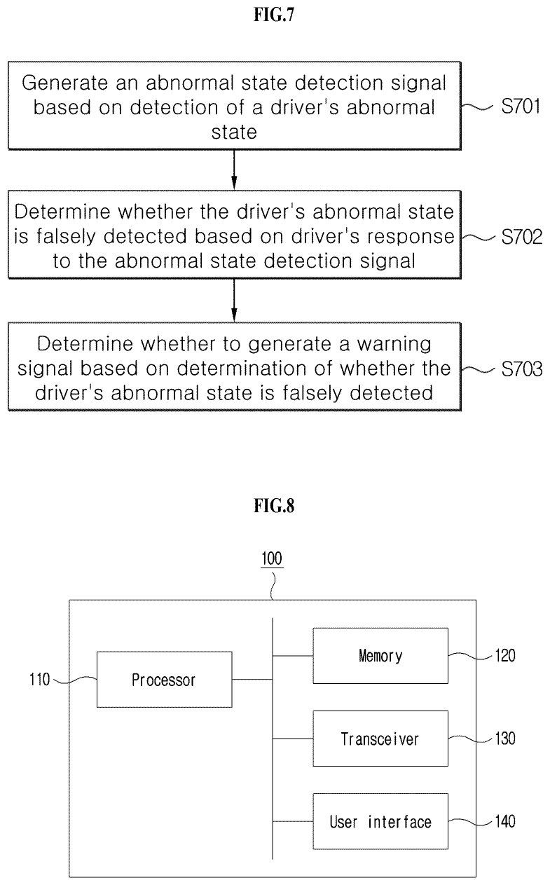

FIG. 7 is a diagram illustrating a method for driver monitoring according to one embodiment of the present invention.

Referring to FIG. 7, a driver monitoring system (or device) generates an abnormal state detection signal based on detection of a driver's abnormal state (S701).

The driver monitoring system (or device) determines whether the driver's abnormal state is falsely detected based on the driver's response to the abnormal state detection signal (S702).

Here, whether the driver's abnormal state is falsely detected can be determined based on data on the driver's normal response to an abnormal state warning message during driving according to a specific driving scenario and data on the driver's abnormal response to an arbitrary warning message.

The driver monitoring system (or device) determines whether to generate a warning signal based on the determination of whether the driver's abnormal state is falsely detected (S703).

Here, the warning signal can be configured to be generated after a preconfigured time from the detection of the driver's abnormal state. Here, based on the determination that the driver's abnormal state is not a false detection, i) the warning signal may be generated, or ii) the warning signal generated after the preconfigured time may be maintained.

In addition, based on the determination that the driver's abnormal state is a false detection within the preconfigured time, the warning signal may be configured not to be generated after the preconfigured time.

In addition, based on the determination that the driver's abnormal state is a false detection after the preconfigured time, the warning signal generated after the preconfigured time may be stopped.

FIG. 8 is a block diagram of a driver monitoring device according to one embodiment of the present invention.

The driver monitoring device 100 may include one or more processors 110, one or more memories 120, one or more transceivers 130, and one or more user interfaces 140. The memory 120 may be included in the processor 110 or may be configured separately. The memory 120 may store instructions that, when executed by the processor 110, cause the driver monitoring device 100 to perform an operation. The transceiver 130 may transmit and/or receive signals and data that the driver monitoring device 100 exchanges with other entities. The user interface 140 may receive a user's input regarding the driver monitoring device 100 or provide an output of the apparatus 100 to the user. Among the components of the driver monitoring device 100, components other than the processor 110 and the memory 120 may not be included in some cases, and other components not shown in FIG. 8 may be included in the driver monitoring device 100.

The processor 110 may be configured to enable the above-described driver monitoring device 100 to perform methods according to various examples of the present disclosure. Although not shown in FIG. 8, the processor 110 may be configured as a set of modules that perform each method/function proposed in this disclosure. Modules may be configured in hardware and/or software form.

The processor 110 generates an abnormal state detection signal based on detection of a driver's abnormal state.

The processor 110 is a system (or device) for driver monitoring determines whether the driver's abnormal state is falsely detected based on the driver's response to the abnormal state detection signal.

Here, whether the driver's abnormal state is falsely detected can be determined based on data on the driver's normal response to an abnormal state warning message during driving according to a specific driving scenario and data on the driver's abnormal response to an arbitrary warning message.

The processor 110 determines whether to generate a warning signal based on the determination of whether the driver's abnormal state is falsely detected.

Here, the warning signal can be configured to be generated after a preconfigured time from the detection of the driver's abnormal state.

Here, based on the determination that the driver's abnormal state is not a false detection, i) the warning signal may be generated, or ii) the warning signal generated after the preconfigured time may be maintained.

In addition, based on the determination that the driver's abnormal state is a false detection within the preconfigured time, the warning signal may be configured not to be generated after the preconfigured time.

In addition, based on the determination that the driver's abnormal state is a false detection after the preconfigured time, the warning signal generated after the preconfigured time may be stopped.

Components described in exemplary embodiments of the present disclosure may be implemented by hardware elements. For example, the hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in exemplary embodiments may be implemented in a combination of hardware and software.

The method according to an embodiment of the present disclosure may be implemented as a program that can be executed by a computer, and the computer program may be recorded in various recording media such as magnetic storage media, optical read media, and digital storage media.

The various technologies described in this disclosure may be implemented as digital electronic circuits or computer hardware, firmware, software, or a combination thereof. The above technologies may be implemented as a computer program product, that is, a computer program tangibly embodied in an information medium (e.g., a machine-readable storage device (e.g., a computer-readable medium) or a data processing device) or a computer program implemented as signals processed by or propagated by a data processing device to cause the operation of the data processing device (e.g., programmable processor, computer, or multiple computers).

Computer program(s) may be written in any form of programming language, including compiled or interpreted languages and may be distributed as a stand-alone program or in any form, including modules, components, subroutines, or other units suitable for use in a computing environment. A computer program may be executed by a single computer or by multiple computers distributed at one site or multiple sites and interconnected by a communications network.

Examples of processors suitable for executing computer programs include general-purpose and special-purpose microprocessors, and one or more processors in digital computers. Typically, a processor receives instructions and data from read-only memory, random access memory, or both. Components of a computer may include at least one processor for executing instructions and one or more memory devices for storing instructions and data. Additionally, the computer may include one or more mass storage devices for data storage, such as magnetic, magneto-optical disks, or optical disks, or may be connected to the mass storage devices to receive and/or transmit data. Examples of information media suitable for implementing computer program instructions and data include optical media such as semiconductor memory devices (e.g., magnetic media such as hard disks, floppy disks, and magnetic tapes), compact disk read-only memory (CD-ROM), digital video disk (DVD), etc., magneto-optical media such as floptical disks, and read only memory (ROM), random access memory (RAM), flash memory, erasable programmable ROM (EPROM), electrically erasable programmable ROM (EEPROM), and other known computer-readable media. Processors and memories can be supplemented or integrated by special-purpose logic circuits.

A processor may run an operating system (OS) and one or more software applications that run on the OS. The processor device may also access, store, manipulate, process and generate data in response to software execution. For simplicity, the processor device is described in the singular, but those skilled in the art will understand that the processor device may include a plurality of processing elements and/or various types of processing elements. For example, a processor device may include a plurality of processors or a processor and a controller. Additionally, different processing structures, such as parallel processors, may be configured. Additionally, computer-readable media refers to all media that a computer can access, and may include both computer storage media and transmission media.

Although this disclosure includes detailed descriptions of various detailed implementation examples, the details should not be construed as limiting the invention or scope of the claims proposed in this disclosure, but rather illustrating features of specific exemplary embodiments.

Features individually described in exemplary embodiments in this disclosure may be implemented by a single exemplary embodiment. Conversely, various features described in this disclosure with respect to a single exemplary embodiment may be implemented by a combination or appropriate sub-combination of a plurality of exemplary embodiments. Furthermore, in the present disclosure, the features may operate by a specific combination, and the combination may initially be described as claimed, however, in some cases, one or more features may be excluded from the claimed combination, or claimed combinations may be modified in the form of sub-combinations or modifications of sub-combinations.

Similarly, even if operations are depicted in a specific order in the drawings, it should not be understood that execution of the operations in a specific order or sequence is necessary, or that performance of all operations is required to obtain a desired result. In certain cases, multitasking and parallel processing can be useful. Additionally, it should not be understood that the various device components in all exemplary embodiments are necessarily separate, and the above-described program components and devices may be packaged in a single software product or multiple software products.

The exemplary embodiments disclosed herein are illustrative only and are not intended to limit the scope of the disclosure. Those skilled in the art will recognize that various modifications may be made to the exemplary embodiments without departing from the scope of the claims and their equivalents.

Accordingly, this disclosure is intended to include all other substitutions, modifications and changes that fall within the scope of the following claims.

What is claimed is:

1. A method for driver monitoring, the method comprising:
generating an abnormal state detection signal based on detection of a driver's abnormal state;
determining whether the driver's abnormal state is falsely detected based on a driver's response to the abnormal state detection signal; and
determining whether to generate a warning signal based on determination of whether the driver's abnormal state is falsely detected,
wherein the warning signal is configured to be generated after a preconfigured time from detection of the driver's abnormal state.

2. The method of claim 1, wherein whether the driver's abnormal state is falsely detected is determined based on data on a driver's normal response to a warning message for an abnormal state during driving according to a specific driving scenario and data on a driver's abnormal response to a random warning message.

3. The method of claim 1, wherein based on determination that the driver's abnormal state is not falsely detected, i) the warning signal is generated, or ii) the warning signal generated after the preconfigured time is maintained.

4. The method of claim 1, wherein based on determination that the driver's abnormal state is falsely detected within the preconfigured time, the warning signal is configured not to be generated after the preconfigured time.

5. The method of claim 1, wherein based on determination that the driver's abnormal condition is falsely detected after the preconfigured time, the warning signal generated after the preconfigured time is stopped.

6. An apparatus for driver monitoring, the apparatus comprising:
at least one processor; and
at least one memory operably connected to the at least one processor and storing instructions that, when executed by the one or more processors, cause the apparatus to perform operations comprising:
generating an abnormal state detection signal based on detection of a driver's abnormal state;
determining whether the driver's abnormal state is falsely detected based on a driver's response to the abnormal state detection signal; and
determining whether to generate a warning signal based on determination of whether the driver's abnormal state is falsely detected,
wherein the warning signal is configured to be generated after a preconfigured time from detection of the driver's abnormal state.

7. The apparatus of claim 6, wherein whether the driver's abnormal state is falsely detected is determined based on data on a driver's normal response to a warning message for an abnormal state during driving according to a specific driving scenario and data on a driver's abnormal response to a random warning message.

8. The apparatus of claim 6, wherein based on determination that the driver's abnormal state is not falsely detected, i) the warning signal is generated, or ii) the warning signal generated after the preconfigured time is maintained.

9. The apparatus of claim 6, wherein based on determination that the driver's abnormal state is falsely detected within the preconfigured time, the warning signal is configured not to be generated after the preconfigured time.

10. The apparatus of claim 6, wherein based on determination that the driver's abnormal condition is falsely detected after the preconfigured time, the warning signal generated after the preconfigured time is stopped.

11. At least one non-transitory computer-readable medium storing at least one instruction, wherein the at least one instruction executable by at least one processor controls an apparatus for driver monitoring to:
generate an abnormal state detection signal based on detection of a driver's abnormal state;
determine whether the driver's abnormal state is falsely detected based on a driver's response to the abnormal state detection signal; and
determine whether to generate a warning signal based on determination of whether the driver's abnormal state is falsely detected,
wherein the warning signal is configured to be generated after a preconfigured time from detection of the driver's abnormal state.
